(19) United States
(12) Patent Application Publication
(10) Pub. No.: US 2013/0029149 A1
(43) Pub. Date: Jan. 31, 2013

(54) FLOATING CORD

(71) Applicant: Sen-Mei CHENG, Chang Hwa Hsien (TW)

(72) Inventor: Sen-Mei CHENG, Chang Hwa Hsien (TW)

(73) Assignee: TAIWAN PAIHO LIMITED, CHANG HWA HSIEN (TW)

(21) Appl. No.: 13/311,485

(22) Filed: Dec. 5, 2011

(30) Foreign Application Priority Data
Jul. 28, 2011 (TW) 100213926

(51) Int. Cl. B32B 1/06; D02G 3/36

(52) U.S. Cl. 428/365; 428/376

(57) ABSTRACT

A floating cord is provided, and includes a surface layer, a tube, and a plurality of floating members. The floating members are disposed in the tube, and the tube is disposed in the surface layer. The floating cord can float on water so that it can be used to connect to keys or glasses to prevent the keys or glasses from sinking into water.

### RELATED APPLICATIONS

The application claims priority to Taiwan Application Serial Number 100213926, filed Jul. 28, 2011, which is herein incorporated by reference.

### BACKGROUND

1. Field of Invention

The present invention relates to a cord. More particularly, the present invention relates to a floating cord.

2. Description of Related Art

While swimming or playing in the water, a user often wears a woven strap (cord) on his or her hand for carrying a key or other belongings. However, with the addition of the weight of a key, the material of the conventional woven strap (cord) will easily allow the key to sink into the water. Hence, the key may become lost.

### SUMMARY

The present invention provides a floating cord. The floating cord includes a surface layer, a tube, and a plurality of floating members. The tube is disposed in the surface layer, and the floating members are placed in the tube. The floating cord is floatable on water.

According to an embodiment of the present invention, the surface layer is made of a woven material.

According to an embodiment of the present invention, the surface layer is made of a plastic material.

According to an embodiment of the present invention, at least one of the surface layer, the tube and the floating members is water-absorbent, and the floating cord has a specific gravity which is less than one after absorbing water.

According to an embodiment of the present invention, the floating members are formed as granules.

According to an embodiment of the present invention, the floating members are made of styrofoam.

According to an embodiment of the present invention, the floating members are made of foam.

According to an embodiment of the present invention, the floating cord further includes a connector, wherein the connector is disposed on at least one end portion of the floating cord.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a partial perspective view of a floating cord according to one embodiment of the present invention, in which a portion of a surface layer of the floating cord is cut away to better show the inner structure of the floating cord; and

FIG. 2 is a perspective view of the floating cord shown FIG. 1, showing buckles connected to the floating cord.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

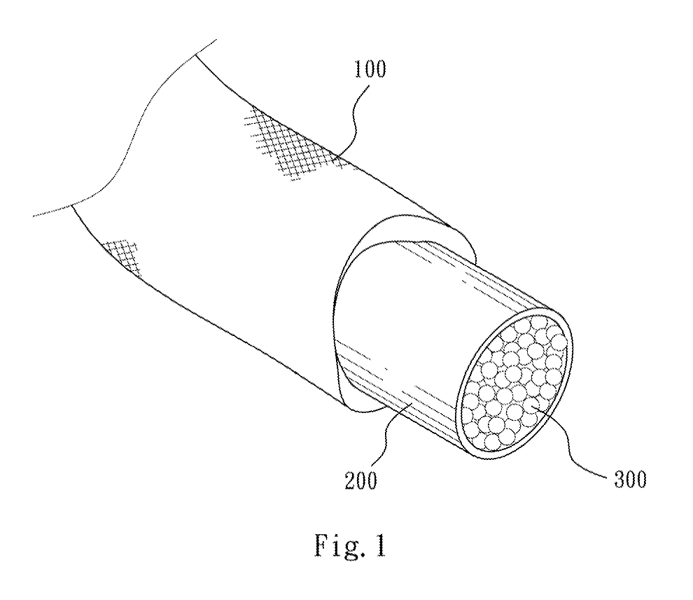

FIG. 1 illustrates a partial perspective view of a floating cord according to one embodiment of the present invention. The floating cord includes a surface layer 100, a tube 200, and a plurality of floating members 300. The tube 200 is located in the surface layer 100, and the floating members 300 are disposed in the tube 200.

The surface layer 100 completely covers an outer surface of the tube 200), and the tube 200 is used for receiving the floating members 300. The floating members 300 are formed from a floatable material, and are filled in the tube 200 to make the floating cord float on water.

The surface layer 100 can be made of a woven material, in which the woven material has the features of being light-weight, soft, comfortable, etc. In some embodiments, the surface layer 100 can be made of a lightweight and strong plastic material.

At least one of the surface layer 100, the tube 200 and the floating members 300 is water-absorbent, and the floating cord will have a specific gravity less than one after absorbing water. In some embodiments, the floating members 300 can be formed from a non-absorbent material, such as styrofoam, foam, etc. In some embodiments, the floating members 300 can be formed as granules which are filled in the tube 200. Such a configuration allows for favorable cord bending.

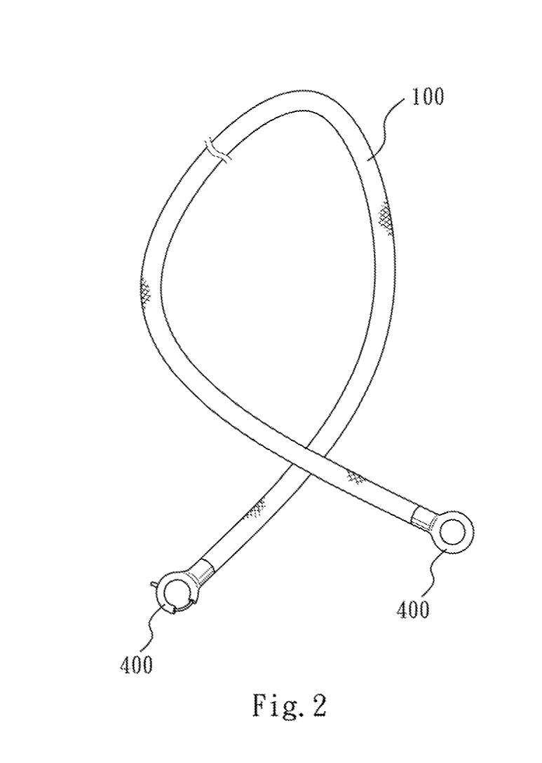

FIG. 2 illustrates a perspective view of the floating cord shown in FIG. 1, showing buckles connected to the floating cord. The floating cord includes at least one connector 400 which is connected to the surface layer 100 of the floating cord and disposed on at least one end portion of the floating cord.

The connector 400 can be a socket, a buckle, a clip, an adhesive member, etc., for connecting the floating cord with other articles including glasses, keys and other personal belongings. When the articles connected to the floating cord fall into the water, the floating property of the floating cord will enable the articles to float on the water.

According to the aforementioned embodiments of the present invention, by utilizing the floating property of the floating cord, the floating cord can be used to connect to personal belongings so that the personal belongs float on water, thus preventing loss of personal belongs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A floating cord, comprising:
a surface layer;
a tube disposed in the surface layer; and
a plurality of floating members disposed in the tube,
wherein the floating cord is floatable on water.

2. The floating cord of claim 1, wherein the surface layer is made of a to woven material.

3. The floating cord of claim 1, wherein the surface layer is made of a plastic material.

4. The floating cord of claim 1, wherein at least one of the surface layer, the tube and the floating members is water-absorbent, and the floating cord has a specific gravity less than one after absorbing water.

5. The floating cord of claim 1, wherein the floating members are formed as granules.

6. The floating cord of claim 1, wherein the floating members are made of styrofoam.

7. The floating cord of claim 1, wherein the floating members are made of foam.

8. The floating cord of claim 1, further comprising a connector, wherein the connector is disposed at an end portion of the floating cord.
